(19) United States
(12) Patent Application Publication
(10) Pub. No.: US 2007/0282638 A1
(43) Pub. Date: Dec. 6, 2007

(54) ROUTE BASED METHOD FOR DETERMINING COST OF AUTOMOBILE INSURANCE

(76) Inventor: Martin Surovy, (US)

Correspondence Address: MARTIN SUROVY, 45A SOUTH BOULEVARD, APT 2W, OAK PARK, IL, 60302, US

(21) Appl. No.: 11/422,083

(22) Filed: Jun. 4, 2006

(51) Int. Cl. G06Q 40/00

(52) U.S. Cl. 705/4

(57) ABSTRACT

A method and system of determining cost of automobile insurance based on safety characteristics of road segments comprising routes expected to be followed on trips insured vehicle and driver have made or are expected to make over the time period the insurance contract is in force. The method comprises steps of identifying the trips, selecting routes expected to be followed on the said trips, determining the probability of each selected route being followed on a trip, evaluating the safety characteristics of roads comprising the routes, consolidating the route safety information with the assigned route probabilities and other risk classifications to produce cost of insurance for the identified trips. The results are further consolidated with the cost of insurance due to risk exposures other than those of the identified trips to produce a final insurance cost.

### BACKGROUND OF THE INVENTION

The present invention relates to data acquisition and processing systems and in particular to systems that consider movement of insured driver and vehicle in determination of automobile insurance cost.

Conventional methods for determining costs of automobile insurance involve classification of driver, vehicle, use of vehicle, type of cargo and type of operation (if a vehicle is used in a commercial operation) into broad actuarial classes for which the expected insurance cost can be predicted with reasonable accuracy based on the empirical experience of the insurer. The basic costs determined by the actuarial classification can be further adjusted by discounts and surcharges. The discounts and surcharges are a form of refinement of the classification. The choice of characteristics which will be used to determine the basic cost and which to determine the surcharges and discounts is subjective and to a degree arbitrary.

An important weakness of conventional methods is their failure to include the actual or expected movements of insured vehicle and driver in insurance cost determination. More particularly, the conventional methods fail to consider safety characteristics of roads driven on in such movement. As a result, two drivers in same actuarial class will pay the same price even though one is on average using safer roads and thus can be expected to have fewer insured losses. The conventional pricing methods thus lead to subsidies and unfair insurance cost. As a result there is a need for improvements which would make the pricing methods more reflective of the actual risks the insured driver and vehicle are exposed to.

The more recently suggested methods address the mentioned weaknesses of the conventional automobile insurance pricing by collecting data on vehicle movement from on-board Global Positioning Systems or other on-board devices. The collected information is processed and subsequently communicated to the insurer who periodically adjusts the insurance cost based on the communicated information.

Although these methods address the weaknesses of the traditional methods they have number of drawbacks. The most significant is the additional cost of installing the monitoring and communication equipment in the vehicle and the cost of integrating the method in the current insurer's systems. Another is security and intrusion into privacy since the devices are collecting and communicating the information on insured's movements in a detail with witch the current consumer may not feel comfortable. Yet another weakness of the GPS based methods is that they do not analyze the movement in a concise format based on a trip concept. To build a credible actuarial classification system based on the road safety characteristics requires storing and analyzes movement information for large number of insured drivers and vehicles over number years. Without summarizing the movement into more manageable movement units such as the trips suggested in the present invention the data bases and computational resources necessary would be very costly.

The present invention contemplates a new and improved method for determining costs of automobile insurance which overcomes both the conventional automobile insurance problem of not distinguishing differences in risk exposure based on the movements of the vehicle as well as the shortcoming of more recent methods which rely on on-board instruments to monitor the operation and movements of the insured vehicle. Unlike traditional methods the subject invention will include safety characteristics of roads traveled in estimated movements of the insured vehicle when determining actuarial classifications, discounts and surcharges.

Unlike more recent insurance cost determination methodology, the present invention does not use any on-board instruments to track the vehicle movement but rather estimates the movements based on the information already available as part of the insurance application process, or information present in financial and operational data normally collected in course of business. Compared to the other methods using Global Positioning Systems or similar on-board devices to track the insured vehicle movements the present invention does not require installation of any additional devices and is thus offering lower implementation and operational costs.

Since the information used in present invention to estimate the insured vehicle movement is either public or of type commonly disclosed in insurance application, financial and tax reporting, or normal course of business operation, the proposed invention will be less intrusive into insured's privacy.

The present invention analyzes and stores insured driver and vehicle movements in a summarized format of a trip. A trip in a context of present invention is characterized by starting location, intermediate stops, and final destination. The actual movement between these locations is only estimated. The efficiency of this format allows the storing and analyzing of historical information for actuarial classifications at a lower cost.

Additionally if the vehicle is used in a commercial operation the proposed invention will enable more accurate allocation of the insurance cost to the price of the provided services.

### BRIEF SUMMARY OF THE INVENTION

In accordance with the present invention, there is disclosed a method of determining cost of automobile insurance based upon safety characteristics of road segments making up routes expected to be followed on trips the insured vehicle and driver have made or are expected to make over the time period the insurance contract is in force. The method is comprised of: steps of identifying trips insured driver and vehicle have made or are expected to make over the time the insurance contract is in force based on the information provided by the insured; steps of selecting routes likely to be followed on the said identified trip; steps of determining probabilities the driver will follow the said selected routes; steps of dividing selected routes into uniform road segments and classifying the said road segments based on an actuarial road safety classification; steps of consolidating the road segments' classifications and the corresponding route probabilities to determining trip specific insurance cost; steps of determining trip non-specific insurance cost; steps of consolidating trip specific and non-specific insurance costs to produce a final insurance cost.

The present invention determines the final insurance cost in two components: a trip specific insurance cost, and a non-trip specific insurance cost. The trip specific automobile insurance cost includes in the cost determination the safety characteristics of roads driven on during trips that can be identified based on the information provided by an insured. The non-trip specific insurance cost is reflective of risk exposures other then the risk exposures due to driving on identified trips and is determined by methods similar to those used in current conventional insurance cost determination methods.

In accordance with another aspect of the present invention, the steps of identifying trips comprise recognizing vehicle movements which can be characterized as driving from a starting location, through intermediate stops to a final destination and for which the starting location, intermediate stops and final destination can be identified or inferred from the information provided by the insured. Examples of trips that can be identified when determining the cost of insurance include: trips which are part of the daily commute to work or to school where for each working day within the insurance contract period it can be estimated that the driver and vehicle will make a trip starting from the vehicle's garage address to the address of work place or school and back; trips in commercial cargo delivery where starting location is the place where the first piece of cargo is initially loaded on to the vehicle, where intermediate stops are locations where additional cargo is loaded or off loaded, and the final destination is the last location where the cargo is off loaded; trips in commercial transport where the starting location is the place where the first of the passengers initially boards the vehicle, where intermediate stops are the locations where on board passengers disembark or additional passengers board, and the final destination is the location where last of the passenger disembarks.

In accordance with yet another aspect of the present invention, the selection of routes likely to be followed on an identified trip comprises of: steps of identifying routes connecting the trip's locations; evaluating route characteristics relative to the other routes; and selecting set of routes likely to be followed based on the said evaluation. Examples of characteristics which could be used in selecting a likely route to be followed on an identified trip include but are not limited to: time it takes to travel the route; length of the route; complexity of the route; cost of driving the route; and safety of the route. Examples of routes selected based on the characteristics in the above example include:

shortest route connecting the trip starting location, intermediate stops and final destination; fastest route based on legal speed limit for the road segments comprising the route; fastest route based on average traffic flow speeds; most cost effective route; least complex route; and safest route based on the safety characteristics of the road segments comprising the route.

In accordance with yet another aspect of the present invention, the steps of determining the probability the insured driver will follow a selected route comprise of evaluation of driver and vehicle profiles, cargo type (if a the vehicle is used in a commercial operation) and the route characteristics related to the drivers preference for a route relative to other selected routes. Examples of route characteristics influencing driver's preference for a route are: length of the route relative to the other selected routes; total expected driving time for the route relative to other selected routes; cost of driving the route relative to the cost of driving the other selected routes; relative complexity of a route; and safety characteristics of the route relative to the safety characteristics of the other selected routes for a given trip.

In accordance with yet another aspect of the present invention, the trip specific insurance cost determination comprises of steps of subdividing the said selected routes for a trip into road segments in such a way that each resulting road segment can be classified in unique actuarial class.

In accordance with yet another aspect of the present invention, the trip specific insurance cost determination comprises of additional steps of assigning each said road segment of a selected route to an actuarial class of road safety characteristics. Examples of road segments safety characteristics used in the actuarial classification and in the surcharge or discount determination are: historical per mile frequency and per mile average cost of insurance claims due to accidents on the road segment per mile of the segment; type of road comprising the road segment where an example of a road type would be primary road, secondary road, or interstate highway; number of traffic lanes on the road segment; number of intersections or highway interchanges; number of railroad crossings;separation type of the opposite direction traffic flows where the traffic flows separation type can be either divided or undivided; maximum legal speed limit of the road segment; average legal speed limit of the road segment; average speed of traffic flow on the road segment; segment's traffic density in number of vehicles per mile; geographic information such as but not limited to average, maximum, and minimum elevation of the road segment; the maximum and minimum longitude and latitude for the road segment; demographic information such as for example but not limited to population density of the surrounding area, average income of the population in the surrounding area, or the average age of the population etc; geo-political information as for example but not limited to the state and county through which is the road segment passing; climate and meteorological information over the selected period for the area the road segment is passing through as for example maximum, minimum and average temperature, participation, or an average number of days with temperature under the freezing point.

In accordance with yet another aspect of the present invention, the trip specific insurance cost determination comprises of additional steps of determining discounts and surcharges for each road segment of a selected route based on safety characteristics of the said road segment. There is some overlap between the use of actuarial classes, discounts and surcharges. It will depend on the insurer's historical experience and another business consideration which of the road segment characteristics will be used to determine the actuarial classifications and which to determine the discounts and surcharges.

In accordance with yet another aspect of the present invention, the trip specific insurance cost determination comprises of additional steps of: consolidating the road segments actuarial classifications, discounts or surcharges, and the probabilities assigned to the selected routes to produce an insurance cost for an identified trip; consolidating the insurance cost for all identified trips into the trip specific insurance cost.

One of the benefits of use of the present invention is a system providing more accurate determination of the automobile insurance cost based on the actual or estimated movements of the insured driver and vehicle and on the risk characteristics of roads followed in such movement.

It is another benefit of the present invention that the method for determining or estimating the movements of the insured driver and vehicle does not require installation of any additional equipment and hence the method can be implemented at a lower cost to both the insured and the insurer.

It is yet another benefit of the present invention that the information used to estimate the movement such as the home address, the place of work address or school address, or dispatch logs is usually already being provided in a course of determination of insurance cost by the conventional methods or is part of financial records compiled for financial reporting or in course of normal business operations. Hence the system based on the present invention is easy to implement by interfacing with the insurers and the insured party existing systems and databases.

It is yet another benefit of the present invention that the information collected in the process of estimating the insured driver movement is of a type that is less intrusive in the privacy of the insured thus making the present invention more acceptable to the consumer.

It is yet another benefit of the present invention that insurance cost can be more easily allocated to a particular service provided in the commercial transport operation since the insurance cost is closely associated with particular cargo deliveries or person transport. The said ease of allocation of the insurance cost will enable the commercial companies to more competitively price their services.

It is yet another benefit of the present invention that the information about insured drivers movements can be summarized in a concise format of a trip thus making the storage and compilation of historical information necessary to generate road safety actuarial classifications more cost effective.

Other benefits and advantages of the subject new vehicle insurance cost determination method will become apparent to those skilled in the art upon a reading and understanding of the specifications.

### BRIEF DESCRIPTION OF THE DRAWINGS

The invention may take physical form in a certain parts and steps and arrangements of parts and steps, the preferred embodiments of which will be described in detail in this specification and illustrated in accompanying drawings which form a part of hereof and wherein:

FIG. 1 is a flowchart generally describing the method for determining the automobile insurance cost based on trips insured driver and vehicle have made or are expected to make over the time period the insurance contract is in force;

FIG. 2 is a flowchart illustrating the process of determining the trip specific component of the automobile insurance cost;

FIG. 3 is a flowchart illustrating the process of determining the contribution of a single trip to the trip specific component of the insurance cost;

FIG. 4 is a flowchart illustrating the detail of how the road segment information is consolidated in determination of the contribution of a single trip to the trip specific component of the insurance cost.

### DETAILED DESCRIPTION

Although described with specific reference to automobiles, this invention is also applicable to other operator controlled motor vehicles normally requiring insurance.

The invention consists of a system and a method for determining automobile insurance cost based on safety characteristics of roads driven on in actual or estimated movements of the insured driver and vehicle over the time period the automobile insurance contract is in force, wherein the said movements can be identified and estimated based on the information provided by the insured. The invention breaks down the actual or expected movements of an insured driver and vehicle into trips in which insured driver and vehicle proceed from a starting location, through intermediate stops to a final destination. The term intermediate stop refers in the context of the present invention to a location the insured driver and vehicle are passing through whether or not the driver actually stops there. The method estimates the actual movements on a trip based on starting location, intermediate stops and the final destination by generating routes of road segments connecting these locations on a map. The accuracy of the movement estimate depends on the number of provided intermediate stops. The actual movement on a trip can be completely determined with a sufficient number of intermediate stops. If the insured does not provide a sufficient information to completely describe the trip a number of likely routes is generated and each is assigned a probability based on the route characteristics and number of other factors such as for example driver profile, vehicle type and use, profile of the operation if the vehicle is used for commercial purposes.

Since not all movements of the insured driver and vehicle can be estimated based on the provided information the method determines the insurance cost in two components. One component is based on the movements that can be estimated based on the information provided by the insured and is referred to in the context of the present invention as a trip specific component or a trip specific insurance cost. The other component reflects the risk exposure due to movements of the vehicle which cannot be identified based on the provided information and is referred to as non-trip specific component or non-trip specific cost of insurance.

An example of application of the current invention is determination of cost of private automobile insurance where the vehicle is used to regularly commute to work or school. Some of the insured driver and vehicle movements on a working day can be estimated based on the garage address of the vehicle and the address of the place of work or school provided by the insured in the application process. The set of identified trips in this example would consists of two trips, one to work and one from work for each working day in the time period covered by the insurance contract. In a simplified version of the current invention the movement during each commute trip to work can be estimated by a single route with assigned probability of one such as for example the shortest route connecting the garage address as the starting location to the place of work address as the final destination with no intermediate stops. The commute trip back from work would have the locations reversed. The trip specific component of the insurance cost can be then determined based on the safety characteristics of roads making up the route and driver and vehicle profiles. The non-trip specific component of the insurance cost is determined based on the driver and vehicle profiles and the miles estimated to be driven, other then those which are part of the daily commute to work, by methods similar to those used in current conventional automobile insurance pricing. The two components are then consolidated to produce the final automobile insurance cost.

Another example of an application of the present invention is an automobile insurance of a transportation company, wherein the set of movements of insured vehicles and drivers is estimated based on locations where cargo is being loaded for transport and locations where cargo is delivered. The information consisting of the name of the driver, vehicle identification, type of cargo, addresses of the locations where the cargo is loaded and subsequently delivered can be submitted to the insurer at various intervals through computer network. The information can be submitted by the party associated with vehicle operation or can be obtained automatically by interfacing with existing dispatch, logistics and accounting systems in use by the insured party. Submitted information can optionally include the sequence in which the cargo is loaded and delivered. In absence of this information a delivery sequence is estimated which either minimizes the total cost of delivery or minimizes the time it takes to deliver the various cargo pieces. In the most simple version of the present invention the movement can be estimated by a shortest route starting at the location where the first piece of cargo is loaded, going through the intermediate stops where the other cargo pieces are being loaded or delivered, and ending at a final destination where the last cargo piece in the delivery sequence is off-loaded. In more sophisticated versions of the present invention a number of routes based on other criteria can be generated and each is assigned a probability based on the driver, vehicle and the transport operation profiles. The trip specific component of the insurance cost can be then determined based on the safety characteristics of the roads making up the estimated routes, route probabilities, cargo type, and driver, vehicle and operations profiles. The insured party can be optionally provided with itemized list of the insurance cost for each submitted delivery thus enabling the transport company to more accurately allocate the insurance cost to the provided cargo transport services. An initial estimate for the trip specific insurance cost can be billed at the inception of the policy and periodically adjusted based on the provided information. Alternatively the trip specific insurance component can be billed at daily, monthly or at other intervals through out the policy term.

The non-trip specific cost is determined separately by method similar to the current conventional pricing methodologies at the inception of the policy. It can be later adjusted based on the actual miles driven other then the miles driven on the identified trips.

Referring now to the drawings, wherein the showings are for purposes of illustrating the invention only and not for purposes of limiting the same.

The present invention relies on estimating some of the insured driver and vehicle movements and when illustrating the method it is convenient to break down the determination of the insurance cost into subcomponents corresponding to the components in which the said movement is estimated. In the present invention the most general component of the insured driver and vehicle movement is a trip. A trip is determined by its starting location, intermediate stops and a final destination. A trip for which these locations can be identified from the information provided by the insured is referred to in the context of the present invention as an identified trip. The risk exposure of the insured vehicle and driver driving on identified trips is reflected in the trip specific insurance cost. The risk exposure of the insured driver and vehicle driving on trips which cannot be identified is reflected in the non-trip specific insurance cost. Each trip can be accomplished by following a route and a route consists of the most basic components of road segments.

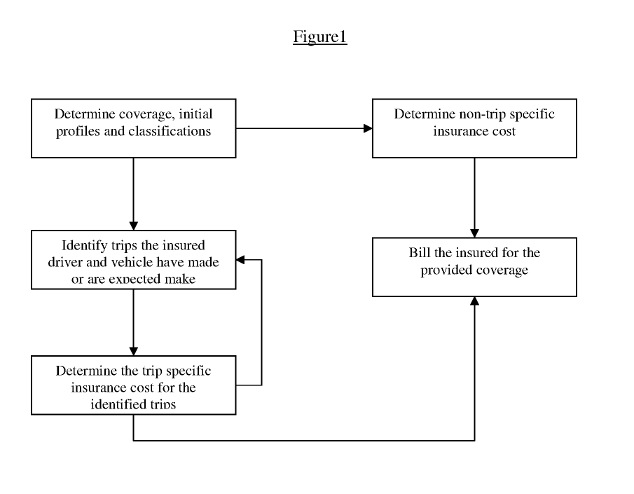

Corresponding to this breakdown the most basic component of the trip specific insurance cost is the road segment's insurance cost where the said cost component reflects the risk exposure of the insured driver and vehicle driving one single time the length of the road segment. The road segments insurance costs are consolidated to produce a route insurance costs which are then further consolidated to produce a trip insurance costs. The trip costs for the identified trips are aggregated to produce the trip specific insurance cost. The FIGS. 1 through 5 illustrate in increasing detail how this can be accomplished.

The FIG. 1 is a flowchart illustrating in general determination of the automobile insurance cost in two separate components, the trip specific insurance cost and the non-trip specific insurance cost. The process illustrated in the flowchart starts similarly as conventional automobile insurance pricing process by determining initial risk profile of drivers and vehicles to produce the actuarial classification needed for automobile insurance cost determination. The initial profiles can be determined on a basis of personal interview, online questionnaire, information retrieval from databanks, on side evaluation of the risk characteristics of a commercial operation, or any other method commonly used to gather the necessary information.

Having determined the initial profiles, the trip specific and the non-trip specific insurance costs are determined separately. The non-trip specific cost is determined by methods similar to those used in current conventional insurance pricing.

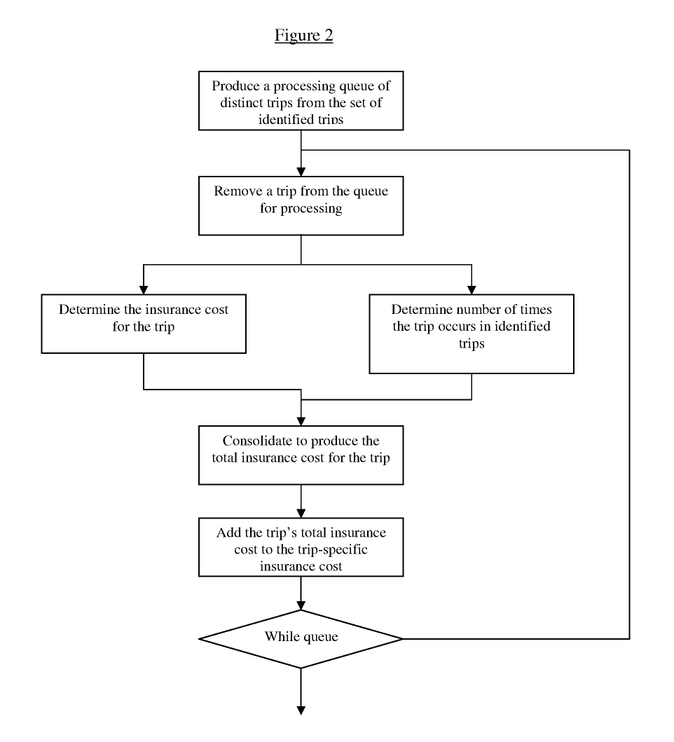

The determination of the trip specific insurance cost comprises of steps of identifying trips the insured driver and vehicle are expected to make over the time the insurance contract is in force and of steps of determining the trip specific insurance cost based on safety characteristics of road segments the insured driver and vehicle are expected to drive on during the said identified trips. The said trips can be identify based on the in the initial interview or based on additional information submitted through out the time period the contract is in force. The determination of the trip specific insurance cost is illustrated in further detail in FIG. 2.

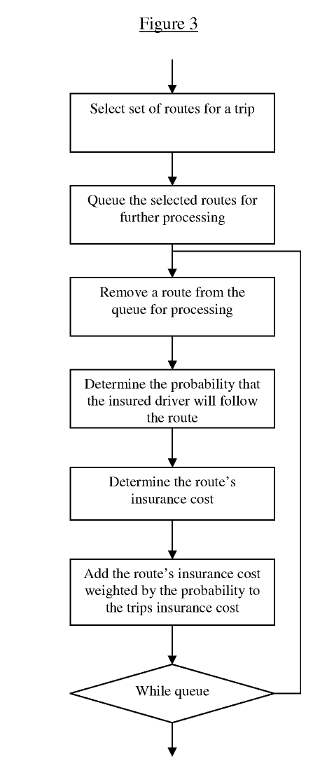

The FIG. 2 is a flowchart illustrating in more detail the determination of trip specific insurance cost based on trips the insured driver and vehicle are expected to make or have made over the time period the insurance contract is in force. The said trips have been identified in prior steps. The set of identified trips can contain trips made or expected to be made multiple times as well as trips made or expected to be made only once. The process as illustrated in FIG. 2 determines how many different or unique trips have been identified in prior steps and how many times each of the unique trips occurs. A queue of the unique trips is formed and separate insurance cost component is determined for each unique identified trip and is later consolidated with the number of times the said trip was made or is expected to be made. The resulting insurance costs are then aggregated to produce the trip specific insurance cost. The determination of a trip specific insurance cost component based on the risk exposure due to a single unique trip is illustrated in further detail in FIG. 3.

FIG. 3 is a flowchart illustrating the determination of a trip insurance cost.

The initial step as illustration in FIG. 3 is to estimate the movements of the insured driver and vehicle on the trip by selecting routes which connect the locations on a trip. In the context of present invention a trip is characterized by a starting location, intermediate stops, and final destination and refers to a movement of the insured driver and vehicle through the said locations in such a manner as to reach the final destination starting from the starting location and driving through the intermediate stops. Depending on number and order of the intermediate stops there may be number of different routes which the insured driver can chose in order to drive from the starting location through the intermediate stops to the final destination. Some of the possible routes connecting the trip locations are selected as a good estimate of the insured driver and vehicle movement on a trip. The route selection is based on characteristics which make a route likely to be chosen by the insured driver. Examples of criteria used in selecting the routes include but are not limited to the length of the route, estimated time it takes to drive the length of the route, estimated cost of driving the length of the route, and safety characteristics of the route. Examples of selected routes include but are not limited to: shortest route connecting the trip starting location, intermediate stops and final destination; fastest route based on legal speed limit for the road segments comprising the route; fastest route based on average traffic flow speeds on the road segments comprising the route; most cost effective route; safest route based on the safety characteristics of the road segments comprising the route.

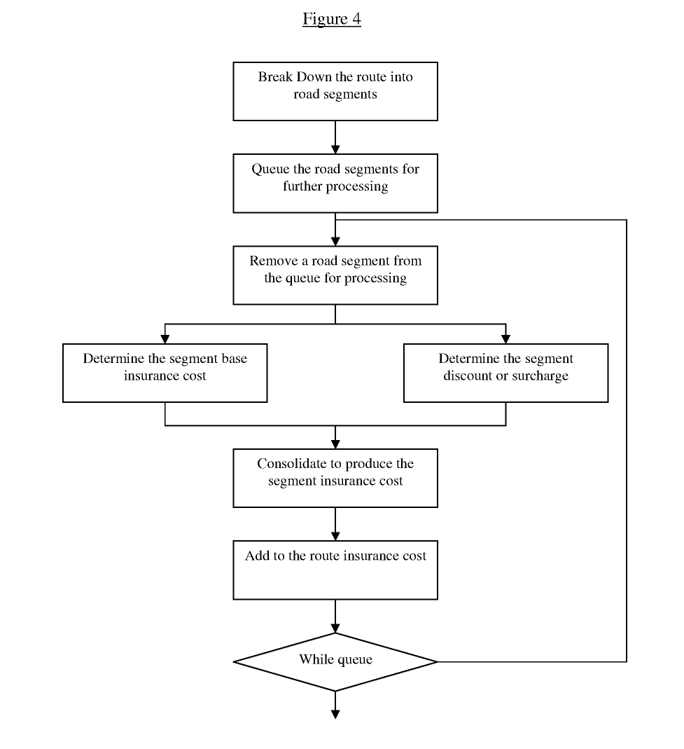

Having selected the routes, they are queued up to determine the routes insurance cost and to assign to each route a probability reflecting an estimate of the insured driver's preference for the route relative to the other selected routes. The determination of the route insurance cost is illustrated in further detail in the FIG. 4. The determination of the route's probability depends on the route characteristics, the insured driver and vehicle profiles and an operation profile if the vehicle is used commercially. Examples of the route characteristics influencing the insured driver preference for a route relative to other selected routes include but are not limited to: length of the route relative to the other selected routes; route's driving time relative to the driving time on the same basis for the other selected routes; relative complexity of the route in number of different roads comprising the route; cost of the route relative to the cost of the other selected routes; safety characteristics of the route relative to the safety characteristics of the other selected routes for a given trip.

Examples of the insured driver and vehicle characteristics influencing the insured driver preference for a route relative to other selected routes include but are not limited to: insured driver age and gender; marital status; vehicle type; vehicles maximum speed; engine size and power; type of cargo if the vehicle is used commercially;

The actual characteristics used and the probabilities they determine can be either based on insurer's historical experience or established by sampling and evaluating the preferences of the insured drivers.

FIG. 4 is a flowchart illustrating the determination of route insurance cost. The first step in the illustration is to subdivide the route into road segments based on classification of the road safety characteristics so that each road segment belongs to a unique class. The length of different segments will vary and in average will depend on the refinement of the road safety classification system. The finer the said classification the shorter on average would the road segments need to be in order to be able to assign each segment to a unique class. An example of road safety characteristics which can form a basis for a road safety classification system includes but is not limited to the following safety characteristics: type of road such as primary road, secondary road, or interstate; type of road surface; number of traffic lanes; type of separation of the opposite direction traffic flows where the traffic flows; maximum and minimum legal speed limit; geographic information such as but not limited to elevation, longitude and latitude range along the road segment; demographic information such as for example but not limited to density, average income, average age of the population in area surrounding the road segment; geo-political information as for example but not limited to state and county through which is the road segment is passing; climate and meteorological information over the time period the insurance is in force for the area the road segment is passing through.

Having subdivided the route, the resulting road segments are queued up to determine the road segment insurance cost where the said insurance cost reflects the risk exposure of the insured driver and vehicle driving one single time the length of the road segment. The road segment insurance cost is determined by combining the road segment base insurance cost with appropriate discounts and surcharges. The base insurance cost is determined as a product of the per mile insurance cost corresponding to the road segments classification and the length of the road segment. The road segment discount or surcharge factors are based on the road segment's safety characteristics other than those used in the base classification, the driver and vehicle profile, use of the vehicle, and operation profile and cargo type if used commercially. The said discounts and surcharges other than those based on the road segment safety characteristics are similar to those used in the conventional automobile insurance pricing.

An example of road segment safety characteristics which can be used to determine the said discounts and surcharges include but are not limited to the following: historical frequency and average cost of insurance claims due to accidents on the road segment;

road type comprising the road segment; number of traffic lanes on the road segment; number and type of road intersections or highway interchanges on the road segment; number of railroad crossings on the road segment; type of separation of the opposite direction traffic flows; maximum legal speed limit; speed of traffic flow;

segment's traffic density in number of vehicles per mile of road; geographic information; demographic information; geo-political information; and climate and meteorological information over the selected period for the area the road segment is passing through;

The choice of which road safety characteristics are used to determine the basic classification and which a premium discount is to a degree arbitrary, however, the set of characteristics used to determine the surcharges and discounts should exclude those used in the classification.

Although the trip specific insurance cost and its components were described with specific reference to automobile insurance cost, this invention is also applicable to methods where the costs are expressed relative to a base.

The invention has been described with reference to preferred embodiments. Obviously, modifications and alterations will occur to others upon a reading and understanding of the specification. It is our intention to include all such modifications and alterations insofar as they come within the scope of the appended claims or the equivalents thereof.

What is claimed is:

1. A method for determining automobile insurance cost based on safety characteristics of roads driven on in actual or estimated movements of the insured driver and vehicle over the time period the automobile insurance contract is in force, the method comprising: identifying trips insured driver and vehicle have made or are expected to make over the time the insurance contract is in force based on the information provided by the insured wherein the said trips are defined by a starting location, intermediate stops and a final destination between which the insured driver and vehicle are expected to drive or have driven in such a manner as to reach the final destination starting from the starting location and driving through the intermediate stops; estimating insured driver and vehicle movements based on starting locations, intermediate stops and a final destinations of identified trips; determining an automobile insurance cost component based on the risk exposure due to the said insured driver and vehicle estimated movements on the identified trips; determining an automobile insurance cost component based on the risk exposure due to driving other than on the said identified trips; consolidating the said insurance cost components into the final insurance cost.

2. The method as described in [claim 1] wherein some or all of the identified trips are identified based on the pattern of daily commute of the insured driver between the place of residence or location of the insured vehicle's garage and the insured driver's place of work or school.

3. The method as described in [claim 1] wherein the vehicle or vehicles are used in a commercial operation and wherein the said trips are identified based on dispatch, accounting, and logistics information comprising the addresses of locations where the cargo pieces are being loaded for transport and the locations where the cargo pieces are being delivered.

4. The method as described in [claim 1] wherein the vehicle or vehicles are used in a commercial operation to transport passengers and wherein the said trips are identified based on dispatch, accounting, and logistics information comprising the addresses of locations where the passengers board for transport and the locations where the passengers disembark.

5. The method as described in [claim 1] wherein estimating insured driver and vehicle movements on an identified trip comprises: finding routes connecting starting location, intermediate stops and final destination; selecting routes likely to be followed on a trip based on the route characteristics, insured driver profile, vehicle type and use, cargo type, and operation profile if the vehicle is used in a commercial operation;
assigning a probability to each said selected route based on the route characteristics, insured driver profile, vehicle type and use, cargo type and operation profile if the vehicle is used in a commercial operation.

6. The method as described in [claim 5] wherein the said determination of an automobile insurance cost component based on the risk exposure due to the insured driver and vehicle estimated movements on identified trips comprises: subdividing the said selected routes for each identified trip into road segments based on a road safety actuarial classification in such a way that each segment is classified in a unique actuarial class;
assigning actuarial classification to the said road segments based on their safety characteristics; determining road segments' automobile insurance cost corresponding to a risk exposure of insured driver and vehicle driving one single time the length of each road segment and where each segment's automobile insurance cost is based on the road segment's actuarial safety classification, length of the road segment and other risk characteristics of the vehicle, driver, and operation if the vehicle is used commercially;
consolidating the road segments' automobile insurance costs and the probabilities of the corresponding routes to produce the automobile insurance cost component corresponding to the risk exposure due to the said insured driver and vehicle estimated movements on identified trips.

7. An insurance claims database matching for each insured the automobile claims due to losses that occurred while driving to a locations where the covered loss occurred.

8. An identified trip database matching the identified trips to an insurance policy, insured driver and vehicle.

9. A system for determining and billing automobile insurance cost based on safety characteristics of roads driven in actual or estimated movements of the insured driver and vehicle over the time period the automobile insurance contract is in force, the system comprising: means for the insured party or a party associated with the operation of the insured vehicles to record, store, revise, and communicate to the insurer vehicle dispatch, accounting, and logistics information needed to identify trips and to compute the automobile insurance cost based on the insured driver and vehicle estimated movements on the said trips; means for the insurer to identify trips and to compute automobile insurance cost based on the identified trips and other information submitted by the insured party or a party associated with the operation of insured vehicles; means for the insurer to communicate insurance cost computed on the basis of the submitted information to the insured party or a party responsible for payment of the said insurance cost.

10. The system as described in [claim 9] wherein the said means for the insured party or a party associated with the operation of the insured vehicles to record, to store, to revise and to communicate to insurer vehicle dispatch, accounting, and logistics information are comprising a computer connected through a computer network to the insurer's computation platform.

11. The system as described in [claim 10] wherein the said means for the insured party or a party associated with the operation of insured vehicles to record, to store, to revise and to communicate to insurer vehicle dispatch, accounting, and logistics information are further comprising a program operational: to record, to store, and to revise information input by the party associated with the operation of the insured vehicles;
to interface and to retrieve information from the insured party's dispatch, accounting, and logistics systems; to communicate information through computer network to programs operational on the insurer's computational platform.

12. The system as described in [claim 9] wherein the said means for the insurer to identify trips and to compute automobile insurance cost based on the information submitted by the insured or a party associated with the operation of insured vehicles is comprising a computer connected through a computer network to the insured party's computer or to a computer of a third party responsible for paying for the provided coverage.

13. The system as described in [claim 12] wherein the said means for the insurer to identify trips and to compute automobile insurance cost based on the information submitted by the insured or a party associated with the operation of insured vehicles are further comprising a program operational: to communicate through computer networks to programs operational on computers used by the insured party or a party associated with the operation of the insured vehicles; to record, to store, and to process information communicated by the insured or party associated with the operation of the insured vehicles; to identify trips based on the information communicated by the insured or a party associated with the operation of insured vehicles; to compute the automobile insurance cost based on the trips identifies from the communicated information; to communicate the said computed insurance cost through computer network to the insured or a party responsible for payment of the insurance cost.
